(19) United States
(12) Patent Application Publication
(10) Pub. No.: US 2009/0034042 A1
(43) Pub. Date: Feb. 5, 2009

(54) Apparatus for Swiveling an Optical Beam

(75) Inventors: Hans Dieter Tholl, Uhldingen-Muhlhofen (DE); Matthias Rungenhagen, Uhldingen-Muhlhofen (DE)

Correspondence Address: LERNER GREENBERG STEMER LLP, P O BOX 2480, HOLLYWOOD, FL, 33022-2480, US

(73) Assignee: DIEHL BGT DEFENCE GMBH & CO. KG, Uberlingen (DE)

(21) Appl. No.: 12/165,966

(22) Filed: Jul. 1, 2008

(30) Foreign Application Priority Data
Jul. 3, 2007 (DE) 10 2007 030 926.2
Aug. 17, 2007 (DE) 10 2007 039 019.1

(51) Int. Cl. G02B 26/08

(52) U.S. Cl. 359/211

(57) ABSTRACT

An apparatus for swiveling an optical beam has a swiveling unit with a number of micro-optical grids for swiveling the beam. In order to compensate for beam errors, such as wavefront aberrations or diffraction effects, the apparatus includes an adaptive optical device with a phase shifter for correction of beam errors in the beam.

### CROSS-REFERENCE TO RELATED APPLICATIONS

This application claims the priority, under 35 U.S.C. § 119, of German applications DE 10 2007 030 926.2, filed Jul. 3, 2007, and DE 10 2007 039 019.1, filed Aug. 17, 2007; the prior applications are herewith incorporated by reference in their entirety.

### BACKGROUND OF THE INVENTION

### Field of the Invention

The invention is based on an apparatus for swiveling an optical beam, having a swiveling unit which comprises a number of micro-optical grids for swiveling the beam.

Laser radars (LADARs) are particularly highly suitable for obstruction warning and for target recognition, in particular for aircraft and missiles. For precise obstruction warning or target recognition, it is advantageous to use an imaging method in which the object scene can be split into a matrix of sections, and in which the individual sections are swiveled either in parallel or sequentially at high speed. To do this, it must be possible to deflect the laser beam over a wide angular range.

Systems comprising rotating mirrors are normally used for laser beam control with wide deflection, and they allow high-speed beam control. Directionally selective deflection is possible by using a universally jointed suspension system, for example as is known from commonly assigned German published patent application DE 10 2004 031 097 A1. Because the moving components of both systems have relatively large masses, they are sensitive to high accelerations. Acousto-optical modulators are less sensitive to acceleration, but their deflection angles are greatly restricted. Microgratings are known for deflection of incident light from imaging apparatuses without an active laser beam for swiveling the object scene, and allow a large deflection to be achieved with very little movement. Such microgratings are known, for example, from commonly assigned German published patent application DE 10 2004 024 859 A1 and its counterpart U.S. Pat. No. 7,214,916 B2.

### SUMMARY OF THE INVENTION

It is accordingly an object of the invention to provide a device for swiveling an optical beam which overcomes the above-mentioned disadvantages of the heretofore-known devices and methods of this general type and which specifies an apparatus that is relatively stable in the presence of accelerations, and by means of which a wide beam deflection can be associated with a high imaging quality.

With the foregoing and other objects in view there is provided, in accordance with the invention, an apparatus for swiveling an optical beam, comprising:

a swiveling unit having a plurality of micro-optical grids for swiveling the optical beam; and

an adaptive optical device with a phase shifter for correcting beam errors in the optical beam.

In other words, this objects of the invention are achieved by an apparatus of the type mentioned initially which comprises an adaptive optical device with a phase shifter for correction of beam errors in the beam. The beam can be deflected over a wide angle by the combination of micro-optical grids and a phase shifter, and beam errors such as wavefront aberrations can be compensated for, without having to keep high-mass elements moving.

The micro-optical grids which can be moved with respect to one another can be used for directional control of the optical beam, thus making it possible to achieve wide beam deflection two-dimensionally over a field of view and/or in an object scene with very little movement. However, it has been found that the use of micro-optical grids to swivel an object scene is normally subject to disturbing beam errors. Beam errors such as these may be caused by the micro-optical grids themselves. During the production of micro-optical lenses for the micro-optical grids, minor physical faults, such as minor lens errors or a minor deviation from exact mutual positioning, in their own right cause wavefront aberrations, that is to say shape errors in wavefronts, and these considerably disturb the swiveling process. However, beam errors can also include diffraction effects caused by the micro-optical grids or wavefront aberrations caused by atmospheric disturbances, for example by hot exhaust gases.

The use of a phase shifter in conjunction with the micro-optical grids makes it possible to counteract beam errors and to improve the quality of swiveling an object scene. The beam errors can be counteracted by modulating the beam—in particular before the beam errors occur—such that the beam errors that are introduced lead to less disturbance in an evaluation image than without modulation.

The micro-optical grids and the phase shifter form so-called adaptive optics, which are able to adapt, that is to say to match, the beam to wavefront errors or beam errors such that they are at least counteracted, that is to say they are therefore compensated for to as great an extent as possible. The apparatus is therefore an apparatus for adaptive swiveling, by virtue of the phase shifter. It can be used as a beam guidance unit, for example in laser swiveling, laser radars (LADARs) and so-called “Directed Infrared Countermeasures” (DIRCM).

In the following text, an optical beam should be understood as meaning a beam composed of electromagnetic radiation in the visible, infrared (IR) and ultraviolet (UV) spectral bands, preferably a laser beam. It may also be a beam which is incident from an object scene. The phase shifter may be an apparatus which allows spatially variable phase modulation, that is to say phase modulation which is produced separately by being driven on a sub-area basis, in the area of the micro-optical grids. The phase shifter is expediently arranged in the beam path upstream of the swiveling unit. The correction for beam errors in the beam need not necessarily be complete, and partial correction, in particular a high degree of correction, is adequate.

In one advantageous embodiment of the invention, the micro-optical grids are microlens arrays. These have no inertia and can be controlled electronically, making it possible to achieve high positioning accuracies and good spatial resolution. Furthermore, wide deflection angles can be achieved. The microlens arrays can expediently be moved laterally with respect to one another and form afocal systems (telescopes). The lateral movement deflects an optical beam incident thereon. In particular, the microlens arrays are in the form of a type of blaze grating.

A number of known “tip/tilt” mirrors, that is to say mirrors which can be tilted in two dimensions, can be used as one embodiment for the phase shifter. A membrane mirror, in which the phase-modulation which can be controlled separately on a sub-area basis is achieved by means of actuators for deformation of the membrane surface, is also possible. It is particularly advantageous, in particular because it is free of macroscopic moving elements, to use a phase shifter, however, which is intended for phase modulation of the beam when the beam passes through an optical material whose characteristics are variable. This can be provided on the basis of liquid crystals, electro-optical, acousto-optical, thermo-optical or fluido-optical materials.

Variations in the optical parameters of the individual microlenses within a microlens array lead to reduced spatial coherence of the interfering beam elements of the individual grid cells in the swiveling unit, and therefore to greater beam divergence. This problem can be counteracted and a high imaging accuracy can be achieved if the adaptive optical device is designed to match the beam to such wavefront aberrations, which are caused by the swiveling unit, in particular as a result of production inaccuracies of the micro-optical grids.

In particular for this purpose, the phase shifter advantageously has shift elements which are arranged in the form of a grid and can be controlled at least largely independently of one another, with each grid cell in a micro-optical grid having at least one associated shift element. This makes it possible to correct for aberrations with a low to medium spatial frequency, which extend over a plurality of grid cells of a micro-optical grid and are of the same size as a grid cell, including offset errors which are caused, for example, by lenses of different thickness.

For this purpose, in particular, the apparatus expediently has a control unit which is provided in order to operate the phase shifter such that offset errors in wavefronts from individual grid elements of the swiveling unit are at least largely compensated for. In this case and in the following text, the expressions “largely” and “essentially” can be understood as meaning compensation for at least 70% of the average phase error.

In order to compensate for waterfront aberrations which are caused by the swiveling unit, in particular by the micro-optical grids, the adaptive optical device may have a detector, an element for aiming the beam at the detector and a control unit which is connected to the detector and is intended to control the phase shifter such that the beam is modulated such that any wavefront aberration produced by micro-optical grids in front of the element is at least essentially eliminated.

Rapid and effective compensation for wavefront aberrations can be achieved if the control unit is intended to carry out the control procedure as closed-loop control, in which the image of the beam on the detector is evaluated. An actual image can be compared with a nominal image, for example a point image, and the phase shifter can be controlled such that the actual image comes as close as possible to the nominal image.

If the apparatus has a control unit having a calibration table, which is stored in a memory, for controlling the phase shifter, then the phase shifter can be controlled—in addition to or as an alternative to closed-loop control—in order to compensate for known aberrations, for example temperature-dependent and deflection-angle-dependent aberrations.

In a further advantageous embodiment of the invention, the phase shifter has shift elements which are arranged in the form of a grid and can be operated at least largely independently of one another, and each grid cell of a micro-optical grid has a plurality of associated shift elements. It is possible to correct aberrations with a high spatial frequency which are smaller than one grid cell, that is to say which form variations within one grid cell and for example are caused by incorrect variation of the focal lengths of the microlenses, or other surface inaccuracies of the microlenses.

For this purpose in particular, the apparatus advantageously has a control unit which is provided in order to operate the phase shifter such that any wavefront aberrations caused by internal physical faults of individual grid elements in the swiveling unit are at least largely compensated for.

Beam errors with an intrinsically low spatial frequency, such as a gradient error in wavefronts from individual grid cells, which are incorrectly arranged somewhat offset with respect to one another, can also be compensated for. For this purpose, the apparatus advantageously has a control unit which is provided in order to operate the phase shifter such that gradient errors in wavefronts from individual grid cells of the swiveling unit are at least largely compensated for.

In another advantageous refinement of the invention, the adaptive optical device is designed to match the beam to wavefront aberrations which are caused by external disturbances, for example atmospheric disturbances. This makes it possible to produce an image with high accuracy despite, for example, hot exhaust gases in the viewing direction, which cause atmospheric disturbances.

For this purpose, the optical device may have a detector, an element for aiming the beam at the detector and a control unit which is connected to the detector and is intended to control the phase shifter such that the emitted beam is modulated such that wavefront aberrations of the incident beam are at least largely eliminated despite external disturbances passing through, in which case, of course, it is not necessary to eliminate all the disturbances.

If the apparatus has an optical feedback device for active closed-loop control of the phase shifter and in particular also of the swiveling unit, then it is possible to compensate quickly and effectively for aberrations, for example caused by atmospheric disturbances.

A physically simple and stable phase shifter can be achieved if the optical device has a number of radiation guides for guidance of light from a radiation source to the swiveling unit, and a shift element of the phase shifter is arranged in each of the radiation guides. In this case, grid cells of the micro-optical grids expediently each have a plurality of associated optical waveguides, so that it is possible to compensate for aberrations with a high spatial frequency.

If the radiation source has a number of radiation elements, with in each case one group of radiation guides, in particular each radiation guide, having an associated radiation element, then it is possible to achieve a high beam intensity.

The phases of the radiation elements can advantageously be controlled individually, and the radiation elements each form the shift element, so that there is no need for separate shift elements.

If aberrations at a low spatial frequency have to be corrected for, then the phase shifter and the micro-optical grids can be arranged in a beam path without any additional aids. If the aim is to correct for aberrations at high or at all spatial frequencies, then it is advantageous to use a lens between the swiveling unit and the phase shifter, such as a lens that is telecentric on both sides, and by means of which the phase structure of the phase shifter can be imaged on the entry pupil of the swiveling unit. The phase structure of the phase shifter can be imaged on the entry pupil of a micro-optical grid or on the surface which comprises pupil elements of the optical functional units of the grid.

Shift elements of the phase shifter may be directly and firmly connected to grid elements of a micro-optical grid, thus making it possible to produce a compact apparatus.

The invention is additionally directed at a method for swiveling an optical beam by means of a swiveling unit having a number of micro-optical grids for swiveling the beam. It is proposed that the beam is matched to beam errors in the beam by means of an adaptive optical device with a phase shifter, such that the beam errors are counteracted.

Other features which are considered as characteristic for the invention are set forth in the appended claims.

Although the invention is illustrated and described herein as embodied in apparatus for swiveling an optical beam, it is nevertheless not intended to be limited to the details shown, since various modifications and structural changes may be made therein without departing from the spirit of the invention and within the scope and range of equivalents of the claims. The drawing and the description contain numerous features in combination which a person skilled in the art will expediently also consider individually and combine them to form worthwhile further combinations.

The construction and method of operation of the invention, together with additional objects and advantages thereof, will be best understood from the following description of specific embodiments when read in connection with the accompanying drawings.

### BRIEF DESCRIPTION OF SEVERAL VIEWS OF THE DRAWINGS

FIG. 1 shows an apparatus for adaptive swiveling of an optical beam using a swiveling unit and an adaptive optical device with a phase shifter, illustrated schematically,

FIG. 2 shows the apparatus with a lens which is telecentric on both sides,

FIG. 3 shows a schematic illustration of positions of the phase shifter,

FIG. 4 shows another illustration of positions of a phase shifter for microlenses which are incorrectly offset with respect to one another,

FIG. 5 shows a further illustration of positions of a phase shifter with internal physical faults in the microlenses,

FIG. 6 shows an apparatus for adaptive swiveling of an optical beam having a control unit for closed-loop control of the phase shifter,

FIG. 7 shows an illustration of a reflected optical beam, which is transmitted in a modulated form,

FIG. 8 shows a tilting unit with upstream optical waveguides, which each conceal a shift element,

FIG. 9 shows controllable-phase fiber lasers upstream of a tilting unit, and

FIG. 10 shows an illustration of an arrangement of optical waveguides on a grid cell.

### DETAILED DESCRIPTION OF THE INVENTION

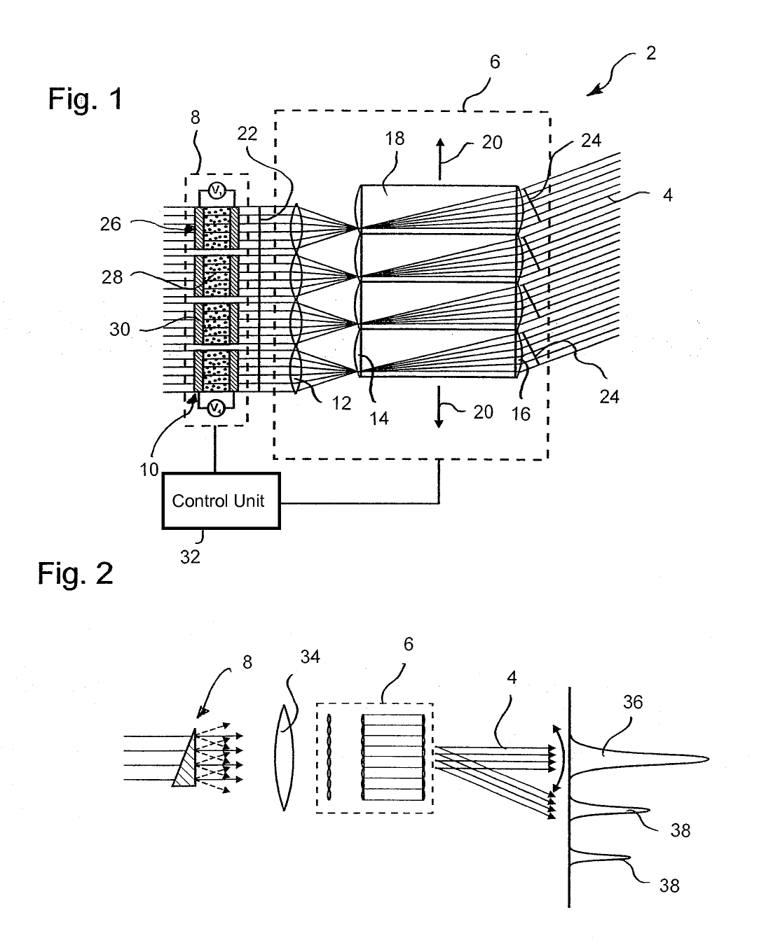

Referring now to the figures of the drawing in detail and first, particularly, to FIG. 1 thereof, there is shown a schematic illustration of an apparatus 2 for adaptive swiveling of an optical beam 4 which is transmitted by an infrared laser, with a tilting unit 6 and an adaptive optical device 8 with a phase shifter 10. The swiveling unit 6 has three micro-optical grids 12, 14, 16 which are in the form of microlens arrays and by which the grids 14, 16 are mounted on a substrate 18 through which radiation can pass, and can be moved jointly laterally with respect to the grid 12 by means of an actuator, as is indicated by the arrows 20. The grids 12, 14, 16 each comprise 256×256 microlenses with a size from several to many tens of microns, with one microlens of each grid 12, 14, 16, that is to say three microlenses in each case, always being associated with one another, and forming an afocal system (telescope). The grid 14 is in this case arranged on the intermediate image plane. A wavefront 22 and therefore the optical beam 4 are deflected by lateral movement of the grids 14, 16, as illustrated by the wavefronts 24.

The phase shifter 10 comprises 256×256 shift elements 26 which are arranged in the form of a grid and can be controlled independently of one another so that each grid cell in the micro-grids 12, 14, 16 has one associated shift element 26. Each grid cell conceals one microlens of each of the grids 12, 14, 16, so that each grid cell has an associated afocal system. Each of the shift elements 26 has optical material 28 with variable characteristics in its interior, which differently influences the phase of the beam passing through the material 28, depending on the electrical voltage between two electrical contacts 30. The electrical voltages, for example V1 and V4 are indicated in FIG. 1, are set by a control unit 32, which is individually connected to all the shift elements 26. For example, the phase shifter may be a so-called spatial light modulator (SLM), in which case liquid-crystal modulators are particularly highly suitable for the near-infrared range from 0.9 μm to 1.7 μm, and can be produced with a size of less than 8 μm, so that they are also suitable for use jointly with, for example, 8×8 shift elements per grid cell. Micro-mirrors or electro-optical ceramics can be used for the mid-infrared range, from 3 μm to 5 μm.

FIG. 2 shows the apparatus 2 with a lens or objective 34 which is telecentric on both sides but which was omitted for the sake of clarity from FIG. 1, by means of which the phase structure of the phase shifter 10 can be imaged on the entry pupil of the swiveling unit 6. This also allows wavefront aberrations with a high spatial frequency to be corrected.

As is illustrated in FIG. 2, the swiveled and transmitted beam 4 forms a diffraction pattern, caused by the grating structure of the micro-optical grids 12, 14, 16, with a main reflection 36 and higher-order secondary reflections 38. Although the grids 12, 14, 16 are in the form of a blaze grating, the beam 4 cannot, however, be satisfactorily guided by them on their own between the reflections 36, 38. However, the phase shifter 8 can be used to align the wavefront 24 such that the beam 4 can be guided between the orders, therefore allowing continuous deflection of the beam 4 without a moving mirror. In this, for example, the phase shifter 10 acts as a phase wedge, as is illustrated by way of example in FIG. 2. In this example, the beam 4 is deflected downwards in the direction of the first diffraction order; an upward deflection is possible if the wedge is changed.

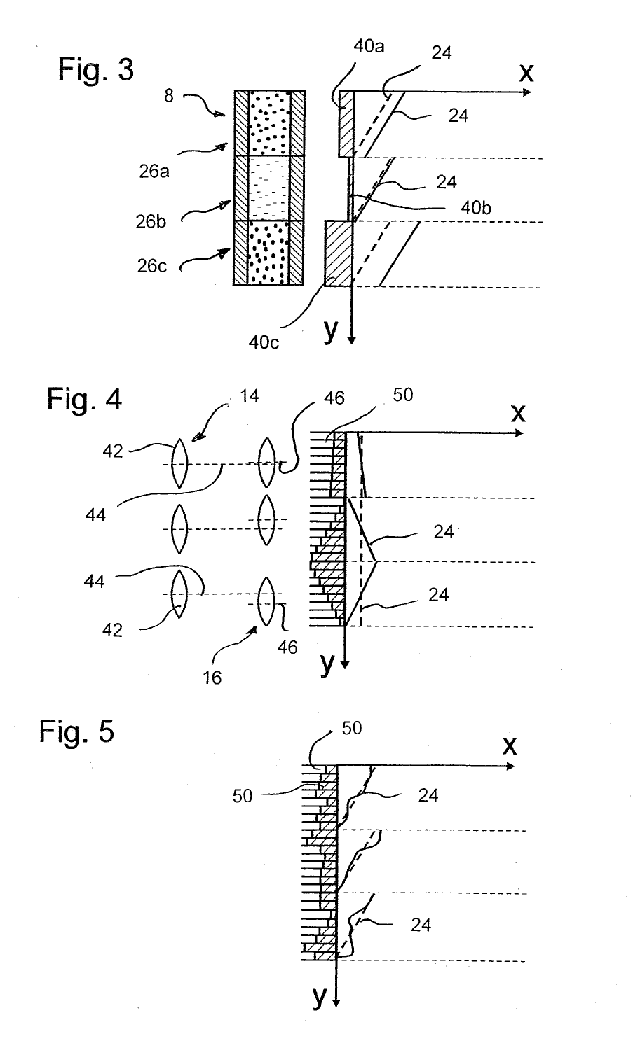

FIG. 3 shows, schematically, a section of the phase shifter 8 with three shift elements 26a, 26b, 26c. The object is to use the tilting unit 6 to tilt the wavefront 24, as illustrated by dashed lines. However, production tolerances result in the microlenses in the grids 12, 14, 16 having different thicknesses, so that although the wavefronts 24 would be correctly tilted without the use of the phase shifter 8, they will have an incorrect offset, however, as is indicated in FIG. 3 by the solid-line representation of the wavefronts 24. Since every afocal system has an associated shift element 26a-c, the offset error can be corrected individually for each system. For this purpose, the optical material 28 with variable characteristics is driven such that it produces a phase shift 40a, 40b, 40c so as to compensate for the offset error, with the wavefront 24 of the beam 4 assuming the desired position, as illustrated by dashed lines.

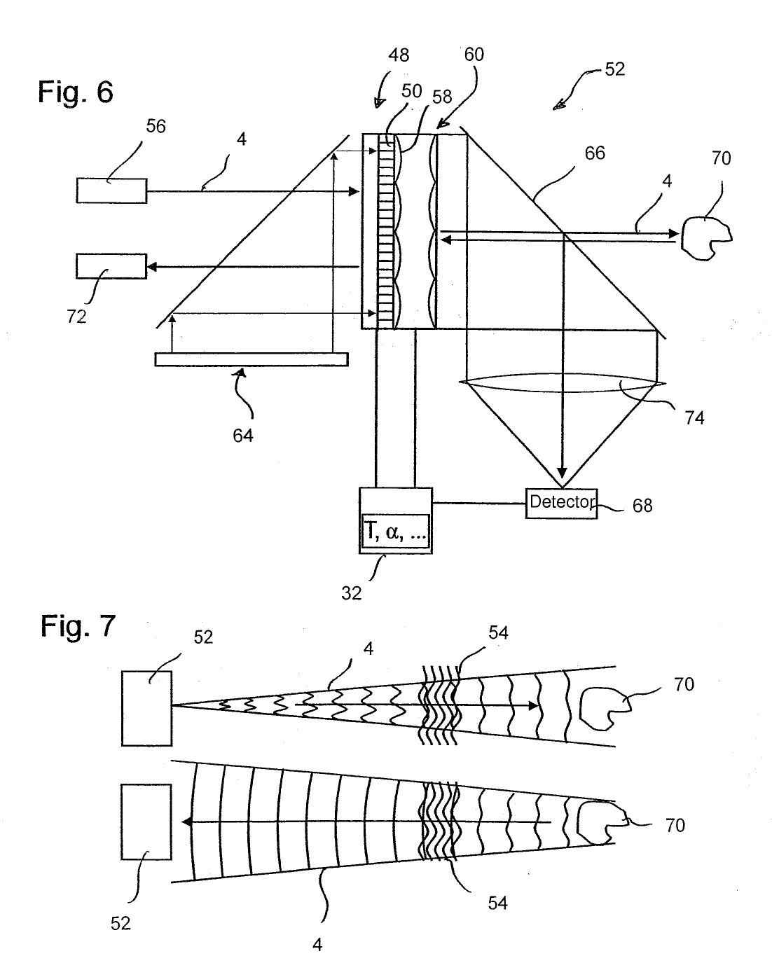

FIG. 4 illustrates the correction of gradient errors of the wavefront 24. Microlenses 42 of the grids 14, 16 are ideally centered on an axis 44. Production tolerances can result in the optical axis 46 of a microlens 42 deviating from the axis 44. In consequence, the respective beam section is undesirably tilted by the relevant microlens 42, and the respective wavefront 24 has a gradient which is incorrect with respect to the desired gradient, as illustrated by dashed lines. In order to compensate for errors such as this, a phase shifter 48 (see FIG. 6) can be provided, in which a plurality of shift elements 50 are in each case associated with one grid cell or one afocal system. Each of these shift elements 50 can be controlled autonomously by the control unit 32. In the example illustrated in FIG. 4, one microlens 42 is in each case associated with 8×8 shift elements 50.

In the case of the microlens 42 illustrated at the top in FIG. 4, the axes 44, 46 differ only slightly from one another, so that the shift elements 50 have phase-shifting effects which differ only slightly from one another. The discrepancy for the microlenses 42 located underneath this is greater, with the incorrect gradient of the wavefronts 24 resulting from this being compensated by the selected state of the shift elements 50—except for a slight step shape in the wavefronts 24, which is not shown.

In the case of the shift elements 50 of the phase shifter 48 as illustrated in FIG. 5, the effects of internal physical faults in individual grid elements are corrected, for example faulty outer surfaces of the microlenses 42 or internal fluctuations in the optical characteristics of the microlenses 42. In this exemplary embodiment as well, each microlens 42 is in each case associated with 8×8 shift elements 50. The physical faults result in the wavefronts 24 being irregularly curved by the microlenses 42, the opposite curvature being applied in advance by the shift elements 50, such that the wavefronts 24 leave the microlenses 42 essentially in a straight line—as indicated by the dashed lines.

FIG. 6 shows, schematically, an apparatus 52 for adaptive tilting of an optical beam 4. This may comprise some or all of the characteristics and components described with reference to the previous figures. The following description is restricted essentially to the differences from the exemplary embodiments from the previous figures, with reference being made to their features and components with the same functions, and which are explicitly encoded in the exemplary embodiment described in the following text. The apparatus 52 has a control unit for closed-loop control of the phase shifter 48, by means of which wavefront aberrations which are caused by external disturbances 54 can be compensated for, for example wavefront aberrations which are caused by striations, in the atmosphere, as is illustrated in FIG. 7.

The apparatus 52 has a radiation source 56 in the form of a laser, whose initially unmodulated beam 4 passes through the phase shifter 48, of a type as described above. The shift elements 50 on the phase shifter 48 are connected directly to grid elements 58 of a micro-optical grid 60, and are attached to them. The shift elements 50 of the phase shifter 48 are optically coded in a known manner by an optical address transmitter 64, which is controlled by the control unit 32, and are in this way set to produce the phase shifts which are in each case caused by the shift elements 50.

The beam 4 which has been modulated by the phase shifter 48 and has been deflected by the grid 60 is aimed by an element 66, for example a semi-reflective mirror, at a detector 68, with the majority of the intensity of the beam 4 being guided out of the apparatus 52 and, for example, to an object 70. From there, the reflected proportion of the beam 4 is reflected back again to the apparatus 52, and is registered by a further detector 72.

That portion of the modulated beam 4 which falls on the detector 68 is imaged by a lens system 74 at one point on the detector 68. The nominal position of the point is known from the position of the grid elements 58 with respect to one another. The control unit 32 which controls the grids 60 compares the nominal position with the actual position and the shape of the image of the beam 4 on the detector 68, and adjusts the phase shifter 48 such that one point is imaged at the nominal position on the detector 68. For this purpose, the control unit 32 has a control program which processes the signals of the detector 68 on the input side, and is connected on the output side to the phase shifter 48. Beam errors caused by the grids 60 are therefore compensated for.

In order to simplify the control task, a calibration table is stored in a memory in the control unit 32, containing an association between physical parameters, such as the temperature T of the apparatus 52, the deflection c of the grids 60 with respect to one another, the wavelength of the beam 4, etc, with respect to states of the phase shifter 48. This data, which is determined in a calibration process, is intended to be used to display a point on the detector 68 very well just by appropriate control, and can also be readjusted by the closed-loop control system.

FIG. 7 schematically illustrates how beam errors caused by the external disturbances 54 can be counteracted. The aim in this case is for the reflected beam 4 to arrive at the detector 72 as free of wavefront aberrations as possible. The beam 4 passes through the disturbances 54 on the way to the object 70 and on the way back to the apparatus 52, and is in each case disturbed by them. In order to obtain an undisturbed beam 4 at the detector 72, the beam 4 must be “predisturbed” in the opposite sense by the phase shifter 48. FIG. 7 shows the beam 4 as if it had passed through the phase shifter 48 only on its way to the object 70, in contrast to the situation illustrated in FIG. 6. The beam 4 leaves the apparatus 52 “predisturbed” and the predisturbance is cancelled out by the disturbances 54, so that it arrives at the detector 72 without any disturbance. In the exemplary embodiment illustrated in FIG. 6, the beam 4 is still partially disturbed when it reaches the apparatus 52, and the disturbance is completely removed by passing through the phase shifter 48 again.

The “predisturbance” or complete cancellation of disturbance is carried out with the aid of image processing, which analyses the image received by the detector 72 and adjusts the phase shifter 48 by means of closed-loop control until the image is largely sharp. In this case, the image processing can be oriented on edges or sharp lines in the image of the object 70. The optical feedback device for active closed-loop control of the phase shifter 48 must in this case be sufficiently fast that the closed-loop control system can produce sharp images in the same time period as changes in the disturbances 54, that is to say within 0.1 s.

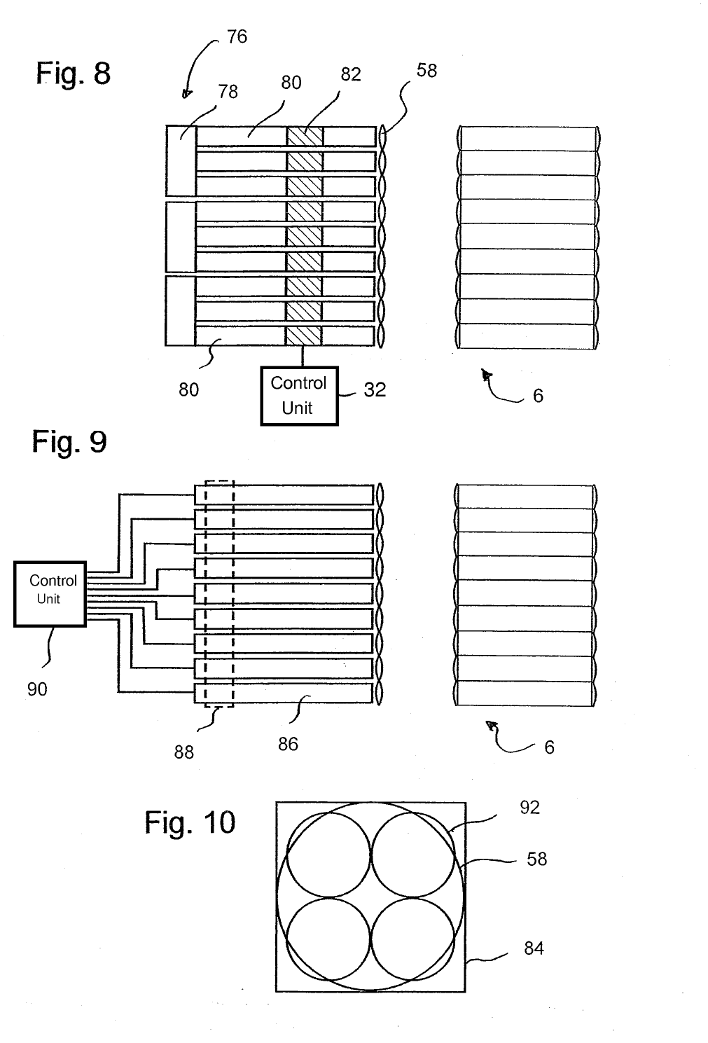

FIG. 8 shows one possible way for beam guidance from a radiation source 76 to the tilting unit 6. The radiation source 76 comprises a plurality of radiation elements 78 in the form of individual lasers, in which infrared light is produced and is passed via radiation guides 80 to the tilting unit 6, for example with each radiation element 78 having a plurality of associated radiation guides 80, and with each grid element 58 or each grid cell 84 (FIG. 10) having an associated radiation guide 80. Each radiation guide 80 has a shift element 82 which can be controlled by the control unit 32, so that all the shift elements 82 can be controlled independently of one another. This makes it possible to compensate for wavefront aberrations, as explained, for example, with reference to FIG. 3.

In the exemplary embodiment illustrated in FIG. 9, radiation guides 86 are in the form of so-called fiber lasers and form dedicated radiation sources. For triggering, they are connected to a central radiation source 88, but their phases can be adjusted individually within limits by a control unit 90, so that they therefore at the same time form shift elements.

In contrast to the exemplary embodiments illustrated in FIGS. 8 and 9, four radiation guides 92 in FIG. 10 are in each case associated with one grid element 58 in a grid cell 84, so that 2×2 shift elements 82 and fiber lasers are available for at least partial compensation for beam disturbances, for each grid element 58.

1. An apparatus for swiveling an optical beam, comprising:
a swiveling unit having a plurality of micro-optical grids for swiveling the optical beam; and
an adaptive optical device with a phase shifter for correction of beam errors in the optical beam.

2. The apparatus according to claim 1, wherein said micro-optical grids are microlens arrays.

3. The apparatus according to claim 1, wherein said phase shifter is configured for phase modulation when the beam passes through an optical material changing a characteristic thereof.

4. The apparatus according to claim 1, wherein said phase shifter includes shift elements disposed in a grid arrangement and drivable substantially independently of one another, and wherein said micro-optical grids have grid cells each having at least one associated shift element.

5. The apparatus according to claim 1, which comprises a control unit configured to operate said phase shifter for compensation of offset errors in wavefronts from individual grid elements of the swiveling unit.

6. The apparatus according to claim 1, wherein said adaptive optical device includes a detector, an element for aiming the beam at said detector, and a control unit connected to said detector and configured to control said phase shifter to modulate the beam so as to substantially eliminate any wavefront aberration produced by micro-optical grids in front of said aiming element.

7. The apparatus according to claim 6, wherein said control unit is configured to control said phase shifter with a closed-loop control, which includes an evaluation of a beam image on the detector.

8. The apparatus according to claim 1, which comprises a control unit with a memory having a calibration table for controlling said phase shifter stored therein.

9. The apparatus according to claim 1, wherein said phase shifter comprises shift elements arranged in a grid and being driven substantially independently of one another, and each grid cell of a respective one of said micro-optical grids has a plurality of associated said shift elements.

10. The apparatus according to claim 1, which comprises a control unit for driving said phase shifter to substantially compensate for wavefront aberrations caused by internal physical faults of individual said grid elements in said swiveling unit.

11. The apparatus according to claim 1, which comprises a control unit for driving said phase shifter to substantially compensate for gradient errors in wavefronts from individual said grid cells of said swiveling unit.

12. The apparatus according to claim 1, wherein said adaptive optical device is configured to match the beam to wavefront aberrations caused by external disturbances.

13. The apparatus according to claim 1, wherein said adaptive optical device includes a detector, an element for aiming the beam at said detector, and a control unit connected to said detector, said control unit controlling said phase shifter to modulate the emitted beam such that wavefront aberrations of the incident beam due to external disturbances are substantially eliminated.

14. The apparatus according to claim 1, which further comprises an optical feedback device connected for active closed-loop control of said phase shifter.

15. The apparatus according to claim 1, which further comprises an optical feedback device connected for active closed-loop control of said swiveling unit.

16. The apparatus according to claim 1, wherein said adaptive optical device includes a plurality of radiation guides for guiding light from a radiation source to said swiveling unit, and wherein a shift element of said phase shifter is disposed in each of said radiation guides.

17. The apparatus according to claim 16, wherein said micro optical grids have grid cells each having a plurality of said radiation guides associated therewith.

18. The apparatus according to claim 16, wherein the radiation source has a plurality of radiation elements each assigned to a respective group of said radiation guides.

19. The apparatus according to claim 16, wherein the radiation source has a plurality of radiation elements each assigned to a respective said radiation guide.

20. The apparatus according to claim 16, wherein the radiation source comprises a plurality of radiation elements with individually controllable phases, and wherein said radiation elements each form a respective said shift element.

21. The apparatus according to claim 1, which comprises a lens disposed between said swiveling unit and said phase shifter, for imaging a phase structure of said phase shifter on an entry pupil of said swiveling unit.

22. The apparatus according to claim 21, wherein said lens is telecentric on both sides thereof.

23. The apparatus according to claim 1, wherein said phase shifter comprises shift elements directly and firmly connected to grid elements of said micro-optical grid.

24. A method of swiveling an optical beam, which comprises:
providing a swiveling unit with a plurality of micro-optical grids for swiveling the beam;
matching the beam to beam errors in the beam by way of an adaptive optical device with a phase shifter, to counteract the beam errors.
